(19) United States
(12) Patent Application Publication
(10) Pub. No.: US 2025/0210029 A1
(43) Pub. Date: Jun. 26, 2025

(54) ACOUSTIC SYSTEM, ACOUSTIC SYSTEM CONTROL METHOD, AND ACOUSTIC SYSTEM MANUFACTURING METHOD

(71) Applicants: Panasonic Automotive Systems Co., Ltd., Kanagawa (JP); Panasonic Connect Co., Ltd., Fukuoka (JP)

(72) Inventors: Tatsuya SHIMIZU, Hyogo (JP); Keisuke FUJIMOTO, Osaka (JP); Koji SANO, Kanagawa (JP); Yasunori MIYAMOTO, Kanagawa (JP)

(73) Assignees: Panasonic Automotive Systems Co., Ltd., Kanagawa (JP); Panasonic Connect Co., Ltd., Fukuoka (JP)

(21) Appl. No.: 18/980,795

(22) Filed: Dec. 13, 2024

(30) Foreign Application Priority Data
Dec. 25, 2023 (JP) 2023-218519

(51) Int. Cl. G10K 11/178; H04R 29/00; H04R 31/00

(52) U.S. Cl. CPC G10K 11/17854; H04R 29/001; H04R 31/00

(57) ABSTRACT

An acoustic system includes: a sound generation device; a vibrator that generates an excitation force to be applied to a vibration member to which the vibrator is attached; and a connection member that is placed between at least one of (i) the sound generation device or a structural member and the vibrator or (ii) the vibrator and the vibration member, and connects the sound generation device or the structural member and the vibration member with the vibrator interposed therebetween.

### CROSS REFERENCE TO RELATED APPLICATION

The present application is based on and claims priority of Japanese Patent Application No. 2023-218519 filed on Dec. 25, 2023.

### FIELD

The present disclosure relates to an acoustic system that actively shields sound waves, an acoustic system control method, and an acoustic system manufacturing method.

### BACKGROUND

Patent Literature (PTL) 1 discloses a technique for reducing vibration of a cabinet of a loudspeaker system by attaching, to the cabinet to which a speaker unit is attached, a vibrator that applies vibration in phase opposite to the phase of vibration of the speaker unit.

### CITATION LIST

### Patent Literature

PTL 1: Japanese Unexamined Patent Application Publication No. H11-32388

### SUMMARY

However, the technique according to the above-described PTL 1 can be improved upon.

In view of this, the present disclosure provides an acoustic system, an acoustic system control method, and an acoustic system manufacturing method which are capable of improving upon the above related art.

An acoustic system according to one aspect of the present disclosure includes: a sound generation device that generates a sound wave based on an acoustic signal; a vibrator that generates an excitation force to be applied to a vibration member to which the vibrator is attached; and a connection member that is placed between at least one of (i) the sound generation device or a structural member and the vibrator or (ii) the vibrator and the vibration member, and connects the sound generation device or the structural member and the vibration member with the vibrator interposed therebetween, the structural member being directly or indirectly connected with the sound generation device.

An acoustic system control method according to one aspect of the present disclosure is an acoustic system control method of controlling an acoustic system that includes a sound generation device that generates a sound wave based on an acoustic signal; a vibrator that generates an excitation force to be applied to a vibration member to which the vibrator is attached; a connection member that is placed between at least one of (i) the sound generation device or a structural member and the vibrator or (ii) the vibrator and the vibration member, and connects the sound generation device or the structural member and the vibration member with the vibrator interposed therebetween, the structural member being directly or indirectly connected with the sound generation device; a sound generation device that generates a sound wave based on an acoustic signal; and a correction filter that corrects the acoustic signal to reduce transmitted sound that has changed from the sound wave by transmitting through the vibration member, and outputs the acoustic signal corrected to the vibrator. The acoustic system control method includes: placing the sound generation device on one side of the vibration member to which the vibrator is attached; placing a measurement device on an other side of the vibration member; obtaining a target measurement signal by causing the measurement device to measure a sound wave generated by the sound generation device based on the acoustic signal; and setting a filter property of the correction filter based on a target sound-pressure transfer function between the acoustic signal and the target measurement signal.

An acoustic system manufacturing method according to one aspect of the present disclosure is an acoustic system manufacturing method of manufacturing an acoustic system that includes a sound generation device that generates a sound wave based on an acoustic signal; a vibrator that generates an excitation force to be applied to a vibration member to which the vibrator is attached; a connection member that is placed between at least one of (i) the sound generation device or a structural member and the vibrator or (ii) the vibrator and the vibration member, and connects the sound generation device or the structural member and the vibration member with the vibrator interposed therebetween, the structural member being directly or indirectly connected with the sound generation device; a sound generation device that generates a sound wave based on an acoustic signal; and a correction filter that corrects the acoustic signal to reduce transmitted sound that has changed from the sound wave by transmitting through the vibration member, and outputs the acoustic signal corrected to the vibrator. The acoustic system manufacturing method includes: placing the sound generation device on one side of the vibration member to which the vibrator is attached; placing a measurement device on an other side of the vibration member; obtaining a target measurement signal by causing the measurement device to measure at least one of (i) a sound wave generated by the sound generation device based on the acoustic signal or (ii) vibration of the vibration member caused by the sound wave generated by the sound generation device; and setting a filter property of the correction filter based on a target sound-pressure transfer function between the acoustic signal and the target measurement signal.

The present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating Example 1 of the application of an acoustic system.

FIG. 2 is a cross sectional view of elements nearby a vibrator of the acoustic system.

FIG. 3 is a diagram illustrating Example 2 of the application of the acoustic system.

FIG. 4 is a diagram illustrating Example 3 of the application of the acoustic system.

FIG. 5 is a perspective view of another example of a connection member, shown together with the vibrator.

FIG. 6 is a diagram illustrating a state of actuating a sound generation device for measurement in a property generation system.

FIG. 7 is a diagram illustrating a state of actuating a vibrator for measurement in the property generation system.

FIG. 8 is a diagram illustrating another example, Example 1, of the property generation system.

FIG. 9 is a diagram illustrating another example, Example 2, of the property generation system.

### DESCRIPTION OF EMBODIMENT

Hereinafter, an embodiment of an acoustic system, an acoustic system control method, and an acoustic system manufacturing method according to the present disclosure will be described with reference to the drawings. It should be noted that the following embodiment presents an example to describe the present disclosure, and thus is not intended to limit the present disclosure. For example, shapes, structures, materials, elements, relative positional relationships, connected states, numerical values, mathematical expressions, details of steps, etc., in methods, orders of the steps in the embodiment below are mere examples, and may include details not described below. Moreover, geometrical expressions such as parallel and orthogonal may be used, but these expressions do not denote mathematical strictness. These expressions include substantially allowable errors, deviations, etc. Expressions such as simultaneous and identical also include a substantially allowable range.

The drawings are schematic diagrams on which emphases, omissions, and/or proportional adjustments are performed as appropriate to describe the present disclosure. Accordingly, the drawings are different from the actual shapes, actual positional relationships, and/or actual proportions. In addition, the X axis, Y axis, and Z axis which may be shown in the drawings denote an orthogonal coordinate system optionally set for describing the drawings. In other words, the Z axis is not limited to an axis extended parallel to a vertical direction, and the X axis and the Y axis are not limited to axes present within a horizontal plane.

The following may comprehensively describe a plurality of inventions as one embodiment. Moreover, some contents stated below are described as optional elements relating to the present disclosure.

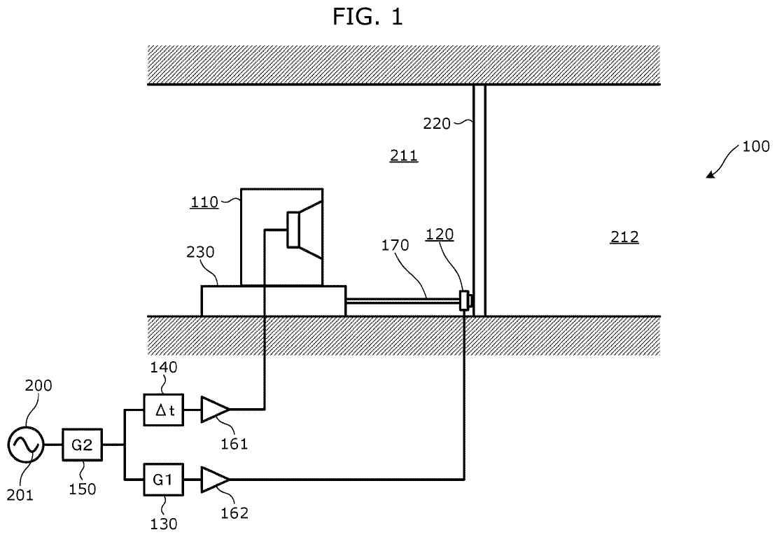

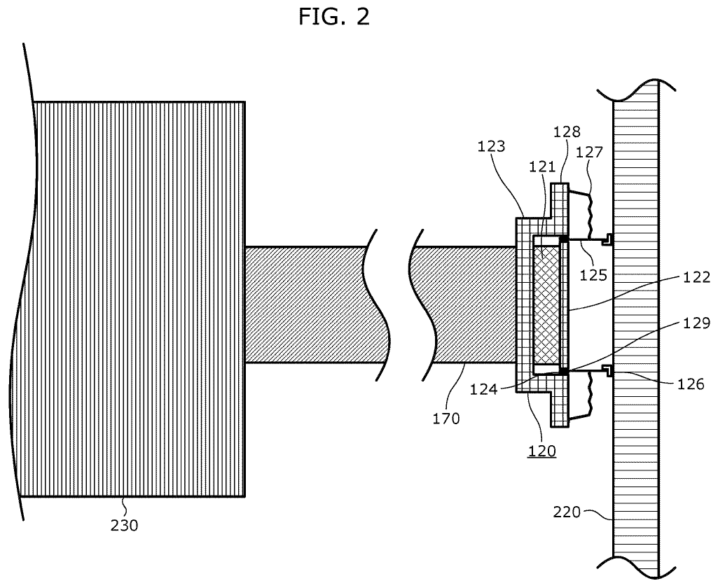

FIG. 1 is a diagram illustrating acoustic system 100. FIG. 2 is a cross sectional view of elements nearby vibrator 120 of acoustic system 100. Acoustic system 100 is a system that causes vibration member 220 to vibrate, and includes vibrator 120 and connection member 170. In the present embodiment, acoustic system 100 is a system that generates sound waves in given first space 211, and in second space 212, decreases the volume of transmitted sound that has transmitted into second space 212 through vibration member 220 by which second space 212 is separated from first space 211. In other words, acoustic system 100 reduces vibration of vibration member 220 caused by the sound waves generated in first space 211. Acoustic system 100 includes sound generation device 110, correction filter 130, delay filter 140, common filter 150, first activation amplifier 161, and second activation amplifier 162.

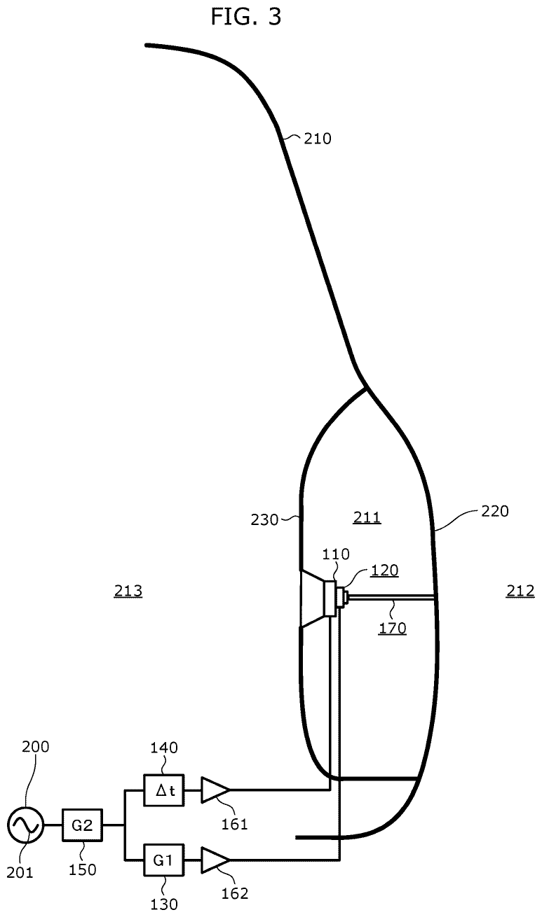

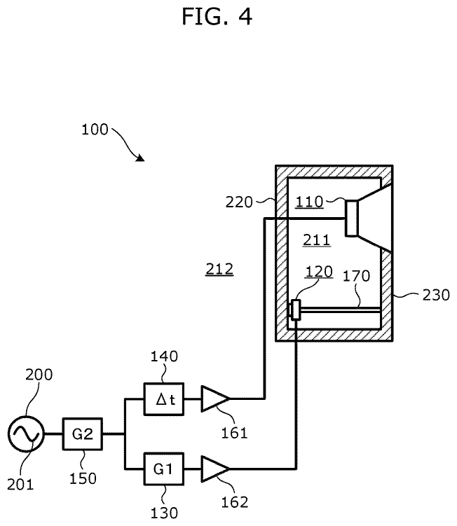

First space 211 is a space in which sound waves are emitted by sound generation device 110. First space 211 is not limited. For example, as illustrated in FIG. 3, first space 211 may be an internal space of mobile object 210, such as vehicles, vessels, and aircraft, which functions as a cabinet (enclosure) that blocks diffraction of back sound emitted from the back of a loudspeaker unit of sound generation device 110 when sound generation device 110 also emits sound in internal space 213 of the mobile object. As illustrated in FIG. 4, first space 211 may also be an internal space of a cabinet (enclosure) of a typical loudspeaker system. In this case, sound generation device 110 also emits sound waves to second space 212.

Second space 212 is a space separated from first space 211 by vibration member 220. Second space 212 is a space into which sound generated by sound source device 110 in first space 211 is desirably leaked as little as possible. Note that first space 211 may be isolated from second space 212 by vibration member 220 or first space 211 and second space 212 may be spatially connected although separated by vibration member 220.

Vibrator 120 is attached to vibration member 220, and is the so-called actuator (excitor) that causes vibration member 220 to vibrate based on an inputted acoustic signal. Vibrator 120 includes a vibration unit that generates an excitation force. Vibrator 120 is a device that generates an excitation force to be applied to vibration member 220 to which vibrator 120 is attached. The type of the vibration unit of vibrator 120 is not limited. For example, the vibration unit may use a piezoelectric element, a magnetostrictor, etc. In the present embodiment, the vibration unit of vibrator 120 is a magnet-type electrodynamic actuator that includes magnet 121, top plate 122, bottom plate 123, voice coil 124, suspension 127, and attachment member 126.

Magnet 121 is a magnetized permanent magnet that is cylindrical in shape.

Top plate 122 is attached to one end face of magnet 121. In the present embodiment, top plate 122 is circular plate-like, has the diameter larger than the diameter of magnet 121, and the central axis of magnet 121 aligns with the central axis of top plate 122.

Bottom plate 123 is attached to the other end face of magnet 121, and is a yoke that guides a magnetic flux that passes through the other end face of magnet 121 to the vicinity of a circumferential surface of top plate 122. In the present embodiment, bottom plate 123 is cylindrical in shape and has a closed end. Flange portion 128 that is annular in shape extends outward from bottom plate 123. Bottom plate 123 coaxially accommodates magnet 121 and top plate 122, and magnetic gap 129 that is annular in shape is formed between top plate 122 and bottom plate 123.

Voice coil 124 is arranged in the magnetic gap, and is a coil to which acoustic signal 201 is input. An interaction between a varying magnetic force that is generated in voice coil 124 and a stationary magnetic force present in magnetic gap 129 causes generation of an excitation force according to acoustic signal 201 in a winding axis direction of a winding axis around which voice coil 124 is wound. In the present embodiment, voice coil 124 is wound around the circumference of bobbin 125 that is cylindrical in shape.

Suspension 127 is a member that elastically connects bobbin 125 and flange portion 128. Suspension 127 supports voice coil 124 and bobbin 125 such that voice coil 124 and bobbin 125 linearly vibrate in the winding axis direction of voice coil 124.

Attachment member 126 is an annular-shaped member to be attached to, for example, vibration member 220. Attachment member 126 is attached to voice coil 124 with bobbin 125 interposed therebetween, and transmits vibration of voice coil 124 to vibration member 220.

With the above-described configuration, the vibration unit of vibrator 120 causes, based on a force generated in voice coil 124, a magnetic circuit that includes magnet 121, top plate 122, and bottom plate 123 and a voice coil body that includes voice coil 124, bobbin 125, and attachment member 126 to relatively reciprocate in the winding axis direction of voice coil 124, to generate vibration. Vibrator 120 can apply vibration according to acoustic signal 201 to vibration member 220 that is bonded to attachment member 126 by adhering to attachment member 126. With this, sound waves according to acoustic signal 201 are generated from vibration member 220. The vibration unit of vibrator 120 as described above includes an internal-magnetic-type magnetic circuit, but the vibration unit of vibrator 120 may include an external-magnetic-type magnetic circuit.

Note that the number of vibration units to be included in vibrator 120 is not limited to one and may be more than one. Vibrator 120 may include three or more vibration units that are suitably not collinearly arranged, but arranged within the same plane or arranged in three-dimensional positions whose movable parts are connected. In the vibrator including a plurality of vibration units whose movable parts are connected, resonance due to oscillation of a movable part which tends to occur in a single vibration unit configuration is reduced by an effect of a moment reaction force generated by distances present between the vibration units. Accordingly, a filter property of correction filter 130 which will be described later in the embodiment is readily set, and thereby bringing an advantage of improving sound insulation performance of acoustic system 100. In this case, activation current of activating vibrator 120 may be acoustic signal 201 that is supplied in parallel to the plurality of vibration units via a single correction filter 130 and a single second activation amplifier 162 or may be acoustic signal 201 individually supplied to the plurality of vibration units via respective correction filters 130 and second activation amplifiers 162.

Vibration member 220 is a member to which vibration is applied by vibrator 120. Vibration member 220 is not limited. For example, as illustrated in FIG. 3, vibration member 220 may be a part or the whole of a door or a part or the whole of the body of mobile object 210, such as vehicles, vessels, and aircraft. Moreover, vibration member 220 may be a wall, a fence, or the like which is provided to separate first space 211 and second space 212. In addition, as illustrated in FIG. 4, when first space 211 is, for example, an internal space of a cabinet (enclosure) of a loudspeaker system, vibration member 220 may be a structural member of the cabinet (enclosure).

Structural member 230 is connected with sound generation device 110, and is disposed at a given distance away from vibration member 220. For example, as illustrated in FIG. 1, structural member 230 is a base on which sound generation device 110 is disposed and to which sound generation device 110 is connected by fastening power of a bolt, etc., adhesion, a static friction force caused by its own weight, or the like. Structural member 230 is not limited. For example, as illustrated in FIG. 3, structural member 230 may be a part or the whole of a door or a part or the whole of the body of mobile object 210, such as vehicles, vessels, and aircraft, with which the loudspeaker unit that is sound generation device 110 is connected. Alternatively, as illustrated in FIG. 4, structural member 230 may be a baffle plate that is a part of the cabinet (enclosure) of a loudspeaker system and with which the loudspeaker unit that is sound generation device 110 is connected. The space between structural member 230 and vibration member 220 is structurally and constantly maintained in a normal state (a state in which a force stronger than the maximum force to be received from vibrator 120 is not applied to at least one of vibration member 220 and structural member 230). Note that the above indication “the space . . . is structurally and constantly maintained” includes a change in distance to the extent that at least one of vibration member 220 and structural member 230 is caused to bend by an excitation force applied by vibrator 120.

Connection member 170 is a member that structurally connects structural member 230 and vibration member 220 with vibrator 120 interposed therebetween. Connection member 170 may be disposed between structural member 230 and vibrator 120 as illustrated in FIG. 1 and FIG. 4 or may be disposed between vibrator 120 and vibration member 220 as illustrated in FIG. 3, for example. Moreover, as illustrated in FIG. 3, vibrator 120 may be attached to a face of sound generation device 110 on the side closer to vibration member 220. Connection member 170 may be disposed between (i) integrally fixed vibrator 120 and sound generation device 110 and (ii) vibration member 220. Connection member 170 may also be disposed between (i) structural member 230 and (ii) integrally fixed vibrator 120 and sound generation device 110. In other words, connection member 170 may structurally connect structural member 230 and vibration member 220, with other elements such as sound generation device 110 and vibrator 120 interposed therebetween. Note that two connection member 170 may be used to structurally connect between vibrator 120 and vibration member 220 and between structural member 230 and vibration member 220.

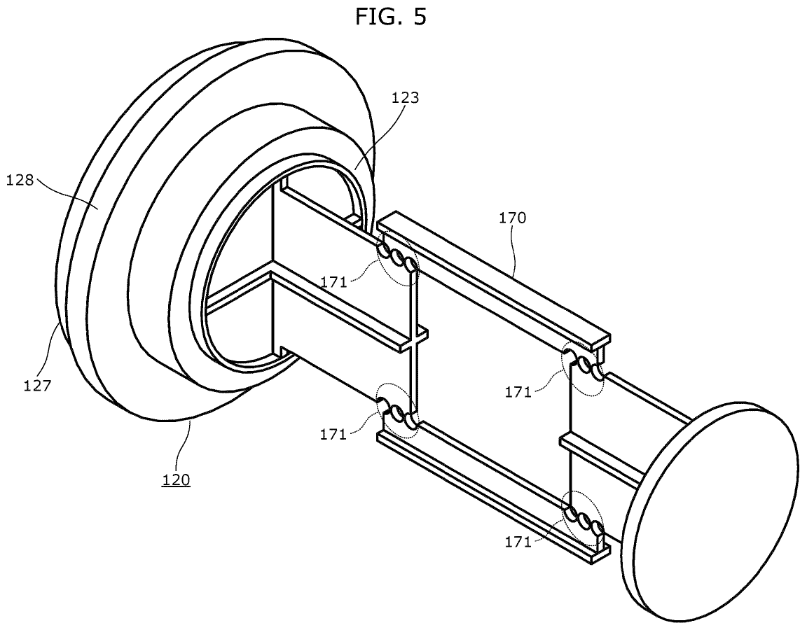

The material and shape of connection member 170 are not limited. Connection member 170 may adopt any optional shape, such as a prism, a cylinder, and a truss structure, as long as the shape has a structural strength that is capable of constantly maintaining each of a distance between connection member 170 and vibrator 120 and a distance between vibrator 120 and structural member 230 in the normal state. Note that, as illustrated in FIG. 5, connection member 170 may at least partially include, in an aligned direction in which vibration member 220 and structural member 230 are aligned (an extension direction in which connection member 170 extends), deformation portion 171 that deforms when a force stronger than the maximum force to be received from vibrator 120 is applied. Deformation portion 171 may deform due to, for example, fracture or may deform due to, for example, plastic deformation. In addition, as illustrated in FIG. 5, deformation portion 171 may be partially included in connection member 170, and the entirety of connection member 170 may function as deformation portion 171. When mobile object 210 to which sound generation device 110 is attached experiences an anomaly, such as a collision, and a great force is applied to connection member 170 in the extension direction in which connection member 170 extends, deformation of deformation portion 171 in connection member 170 prevents vibrator 120 from protruding from vibration member 220 or from structural member 230.

Sound generation device 110 is a device that generates sound waves in first space 211, based on acoustic signal 201 output from signal source 200. The type of sound generation device 110 is not limited. For example, as sound generation device 110, a loudspeaker unit and a vibrator for sound generation which emits sound by causing a target object to vibrate can be presented as examples. Moreover, sound generation device 110 may include, for example, a cabinet (enclosure) that holds a loudspeaker unit and vibration member 220 to which the vibrator for sound generation is to be attached. Sound generation device 110 may also include a plurality of loudspeaker units or a plurality of vibrators for sound generation, or may be a multi-way loudspeaker including various types of loudspeaker units.

Correction filter 130 is a filter that corrects acoustic signal 201 to be output to vibrator 120 so as to reduce transmitted sound that has changed from sound waves that sound generation device 110 has output inside first space 211 by transmitting through vibration member 220 and arriving at second space 212. In the present embodiment, correction filter 130 has a filter property unique to acoustic system 100. A filter property of correction filter 130 is a property determined at least by sound generation device 110, vibrator 120, and vibration member 220 to which vibrator 120 is to be attached. A specific method of setting a filter property of correction filter 130 will be described later in the embodiment.

Delay filter 140 delays acoustic signal 201 to be output to sound generation device 110 by only Δt (fixed value) from acoustic signal 201 to be output to vibrator 120. Note that “t” represents time.

Common filter 150 is a filter that corrects acoustic signal 201 to be output to each of vibrator 120 and sound generation device 110. Common filter 150 is a filter that cuts a signal component that is an amount of sound waves generated by sound generation device 110 which correction filter 130 alone or correction filter 130 and delay filter 140 alone cannot prevent from transmitting through vibration member 220. In the present embodiment, common filter 150 corrects acoustic signal 201 output from signal source 200, before being diverged. Note that common filter 150 may correct each of acoustic signals 201 after being diverged.

First activation amplifier 161 amplifies acoustic signal 201 output from signal source 200 until sound can be emitted in first space 211 by activating sound generation device 110. In the present embodiment, first activation amplifier 161 amplifies acoustic signal 201 that has been corrected by common filter 150 and then by delay filter 140.

Second activation amplifier 162 amplifies acoustic signal 201 output from signal source 200 so as to cause vibration member 220 to vibrate by activating vibrator 120 to reduce an amount of sound waves emitted in first space 211 transmitting into second space 212. In the present embodiment, second activation amplifier 162 amplifies acoustic signal 201 that has been corrected by common filter 150 and then by correction filter 130.

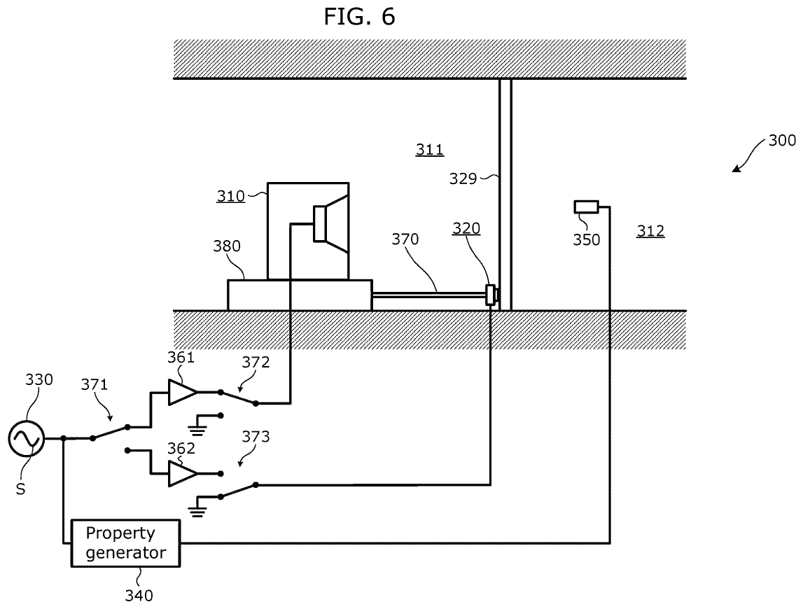

Next, property generation system 300 that can set a filter property of correction filter 130 included in acoustic system 100 will be described. FIG. 6 is a diagram illustrating property generation system 300. Property generation system 300 is a system that generates a filter property of correction filter 130 included in acoustic system 100. Property generation system 300 includes sound generation device 310 for measurement, vibrator 320 for measurement, vibration member 329 for measurement, sound source 330 for measurement, property generator 340, measurement device 350, first measurement amplifier second measurement amplifier 362, first changeover switch 371, second changeover switch 372, and third changeover switch 373.

Sound generation device 310 for measurement is a device that generates, based on measurement acoustic signal S output from sound source 330 for measurement, sound waves in first measurement space 311. Sound generation device 310 for measurement is desirably the same as sound generation device 110 or is desirably the same type of device as sound generation device 110. Moreover, an aspect of attachment of sound generation device 310 for measurement to a cabinet or the like is desirably the same or substantially the same as the aspect of attachment of sound generation device 110. Furthermore, the position, orientation, and the like of sound generation device 310 for measurement relative to vibration member 329 for measurement are desirably the same or substantially the same as the position, orientation, and the like of sound generation device 110 relative to vibration member 220.

Vibrator 320 for measurement is a device that causes vibration member 329 for measurement to vibrate, based on measurement acoustic signal S to be output from sound source 330 for measurement. Vibrator 320 for measurement is desirably the same as vibrator 120 or is desirably the same type of device as vibrator 120. Moreover, an aspect of attachment of vibrator 320 for measurement to vibration member 329 for measurement is desirably the same or substantially the same as the aspect of attachment of vibrator 120 to vibration member 220.

Connection member 370 for measurement is a member structurally connecting structural member 380 for measurement and vibration member 329 for measurement with vibrator 320 interposed therebetween. Connection member 370 for measurement is desirably the same or substantially the same as connection member 170. Moreover, an aspect of connection member 370 connecting structural member 380 for measurement and vibration member 329 for measurement with vibrator 320 for measurement interposed therebetween is desirably the same or substantially the same as the aspect of connection member 170 connecting structural member 230 and vibration member 220 with vibrator 120 interposed therebetween.

Sound source 330 for measurement outputs measurement acoustic signal S. Measurement acoustic signal S need not be acoustic signal 201 to be output to acoustic system 100. As measurement acoustic signal S, the following can be presented as examples: a given acoustic signal 201, a sine curve signal, a sweep sine signal, an impulse signal, a random noise signal, a colored noise signal, a maximum length sequence signal, and a time stretched pulse (TSP) signal.

Measurement device 350 is a device that measures (i) sound waves generated in second measurement space 312 by activating sound generation device 310 for measurement or vibrator 320 for measurement or (ii) vibration of vibration member 329 for measurement caused by activating sound generation device 310 for measurement or vibrator 320 for measurement. As measurement device 350 that measures sound waves, a microphone can be presented as an example. As measurement device 350 that measures vibration, a displacement sensor, a speed sensor, and an acceleration sensor can be presented as examples. Note that property generation system 300 may include a plurality of measurement devices 350.

Property generator 340 derives a filter property of correction filter 130 included in acoustic system 100 based on a target sound-pressure transfer function between target measurement signal Ps and measurement acoustic signal S. Target measurement signal Ps is obtained by measuring, in second measurement space 312 which is not first measurement space 311 in which sound generation device 310 for measurement is placed among two spaces separated by vibration member 329 for measurement, (i) sound waves generated by sound generation device 310 for measurement based on measurement acoustic signal S or (ii) vibration of vibration member 329 for measurement which is caused by the sound waves. In addition to the above, in the present embodiment, property generator 340 derives a filter property of correction filter 130 based on a corresponding sound-pressure transfer function between corresponding measurement signal Pv and measurement acoustic signal S. Corresponding measurement signal Pv is obtained by measuring, at the same position at which target measurement signal Ps has been measured, (i) sound waves generated as a result of vibrator 320 for measurement causing vibration member 329 for measurement to vibrate based on measurement acoustic signals S or (ii) the vibration of vibration member 329 for measurement. Property generator 340 derives the filter property using the Fourier transform. A specific method of deriving will be described later in the embodiment. Property generator 340 is a processor implemented by causing a processor included in a dedicated or general-purpose computer to execute a property generation program.

First measurement amplifier 361 amplifies measurement acoustic signal S output from sound source 330 for measurement until sound can be emitted in first measurement space 311 by activating sound generation device 310 for measurement. First measurement amplifier 361 is desirably the same as first activation amplifier 161 or is desirably the same type of amplifier as first activation amplifier 161.

Second measurement amplifier 362 amplifies measurement acoustic signal S output from sound source 330 for measurement until vibration member 329 for measurement is caused to vibrate by activating vibrator 320 for measurement. Second measurement amplifier 362 is desirably the same as second activation amplifier 162 or is desirably the same type of amplifier as second activation amplifier 162.

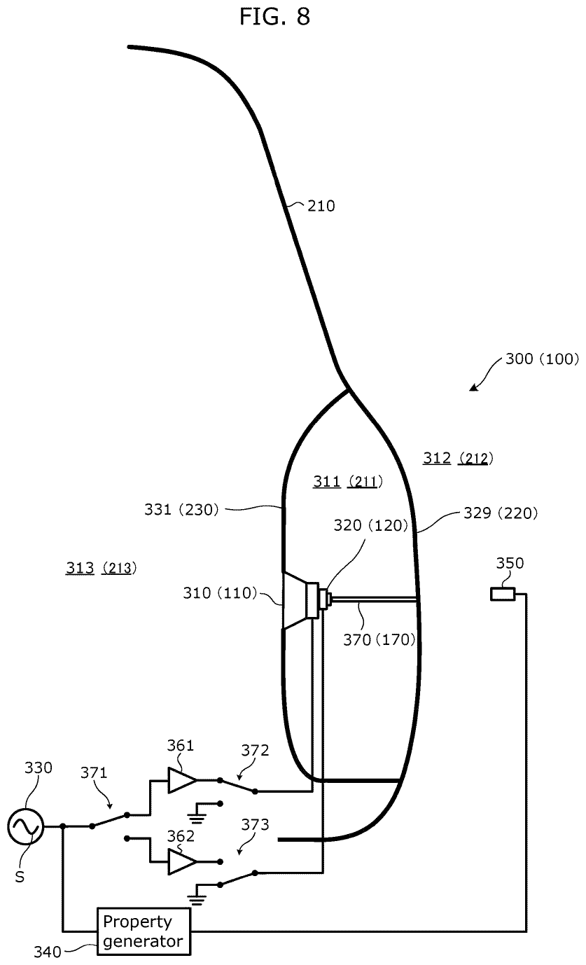

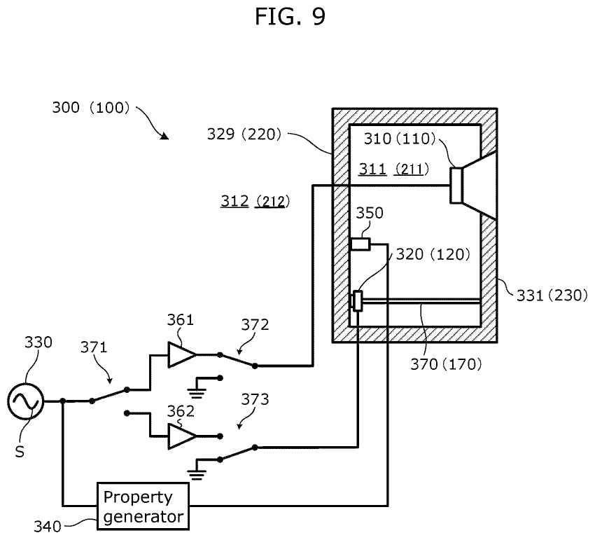

Note that, as illustrated in FIG. 8, property generation system 300 may use a part of acoustic system 100 attached to mobile object 210 to generate a filter property. As illustrated in FIG. 9, property generation system 300 may further use a part of acoustic system 100 that utilizes a cabinet (enclosure) of a typical loudspeaker unit as vibration member 220.

Next, an acoustic system manufacturing method of manufacturing acoustic system 100 using property generation system 300 will be described. As illustrated in FIG. 6, sound generation device 310 for measurement is placed at a given position inside first measurement space 311. Vibrator 320 for measurement and connection member 370 for measurement are attached to vibration member 329 for measurement at a given position on vibration member 329 for measurement. Vibration member 329 for measurement is placed in first measurement space 311 that is on one side of vibration member 329 for measurement to which vibrator 320 for measurement is attached. Measurement device 350 is placed at a given position in second measurement space 312 that is on the other side of vibration member 329 for measurement. When sound waves inside second measurement space 312 are measured, measurement device 350 is placed at a position away from vibration member 329 for measurement. When vibration of vibration member 329 for measurement is measured, measurement device 350 is placed such that measurement device 350 is in contact with vibration member 329 for measurement. In this case, measurement device 350 may be placed inside first measurement space 311. In particular, as illustrated in FIG. 9, when a filter property is generated using a part of acoustic system 100 that utilizes a cabinet (enclosure) of a typical loudspeaker system as vibration member 220, both of sound waves directly emitted from sound generation device 110 and the sound waves that have transmitted through vibration member 220 and propagating inside second measurement space 312 are present in second measurement space 312 (212). This may cause an error in calculating target sound-pressure transfer function Hs that will be described later in the embodiment. In view of the above, in the present embodiment, measurement device 350 measures vibration of vibration member 329 for measurement, and is placed such that measurement device 350 is in contact with vibration member 329 for measurement. With this, it is possible to reduce the entry of sound waves directly emitted from sound generation device 110 into measurement device 350.

First changeover switch 371 and second changeover switch 372 are selected so as to cause sound generation device 310 for measurement to generate sound waves based on measurement acoustic signal S (see FIG. 6). In this case, third changeover switch 373 is selected such that vibrator 320 for measurement is short-circuited.

Target measurement signal Ps is obtained by causing measurement device 350 to measure sound waves generated by sound generation device 310 for measurement or a vibration of vibration member 329 for measurement which is caused by the sound waves. At this stage, property generator 340 may derive filter property G of correction filter 130 based on target sound-pressure transfer function Hs between measurement acoustic signal S and target measurement signal Ps.

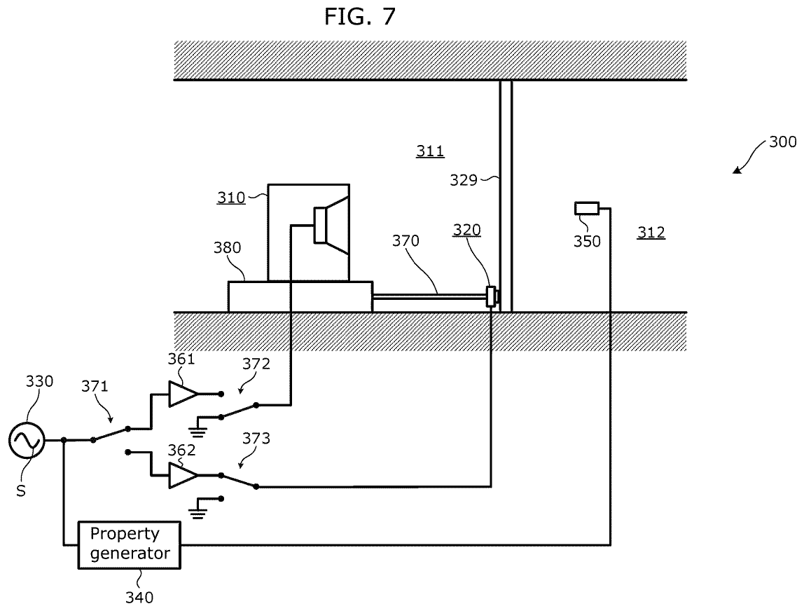

Next, in the present embodiment, first changeover switch 371 and third changeover switch 373 are selected so as to cause vibrator 320 for measurement to apply vibration to vibration member 329 for measurement, based on measurement acoustic signal S (see FIG. 7). In this case, second changeover switch 372 may be selected such that sound generation device 310 for measurement is short-circuited.

Without changing the position of measurement device 350 that has measured target measurement signal Ps, measurement device 350 is caused to measure (i) sound waves generated as a result of vibrator 320 for measurement causing vibration member 329 for measurement to vibrate based on measurement acoustic signal S or (ii) vibration of vibration member 329 for measurement, to measure corresponding measurement signal Pv. Property generator 340 derives a corresponding sound-pressure transfer function Hv between measurement acoustic signal S and corresponding measurement signal Pv, and derives filter property G of correction filter 130 based on precedently-derived target sound-pressure transfer function Hs, using the following mathematical expressions.

Hs=Ps/S

Hv=Pv/S

Inverse function calculation: Hs×S+Hv×G×S=0 From the above, the mathematical expression G=−Hs/Hv holds true.

Acoustic system 100 can be manufactured by setting filter property G of correction filter 130 which has been generated by property generator 340 to correction filter 130 included in acoustic system 100.

Short-circuiting of vibrator 320 for measurement when target measurement signal Ps is measured produces the following advantageous effects. More specifically, sound waves generated by sound generation device 310 for measurement cause vibration member 329 for measurement to vibrate, and this vibration causes an induced current to be generated in internal wiring of vibrator 320 for measurement. Electrical energy of the generated induced current is consumed due to an internal resistance of vibrator 320 for measurement. Due to this electrical energy consumption, vibrator 320 for measurement seemingly behaves as if attenuation of the mechanical vibration system has increased. In acoustic system 100, the above-described state is the same as the state in which vibrator 120 is reducing the vibration of vibration member 220 caused by sound waves generated by sound generation device 110. With this, the accuracy of filter property G to be derived by property generation system 300 can be improved, and the amount of sound waves generated by sound generation device 110 transmitting through vibration member 220 can be effectively reduced.

Note that the present disclosure is not limited to the above-described embodiment. For example, the present disclosure may include different embodiments implemented by optionally combining elements described in the present specification or by excluding some of the elements described in the present specification. Moreover, the present disclosure also includes variations obtained by applying various modifications conceivable to those skilled in the art to each embodiment, without departing from the spirit of the present disclosure, or in other words, without departing from the meaning of wording recited in the claims.

The manufacturing of acoustic system 100 by setting a filter property derived from a measurement result based on property generation system 300 to correction filter 130 has been presented as an example. However, a filter property of correction filter 130 may be derived through a numerical analysis simulation, such as a finite element method (FEM) and lumped element modeling (LEM) (an equivalent circuit analysis method using lumped constant elements), to be set to correction filter 130 of acoustic system 100.

The case where measurement device 350 provided at one position measures target measurement signal Ps and corresponding measurement signal Pv to derive filter property G for correction filter 130 has been described. However, a plurality of measurement devices 350 may be provided at a plurality of positions or measurement device 350 may change positions to measure a plurality of target measurement signals Ps and a plurality of corresponding measurement signals Pv and may derive filter property G based on the plurality of target measurement signals Ps and the plurality of corresponding measurement signals Pv. In this case, a statistical process such as a least-square method may be performed on the plurality of target measurement signals Ps and the plurality of corresponding measurement signals Pv to calculate a single target measurement signal Ps and a single corresponding measurement signal Pv, and filter property G may be derived using these calculated measurement signal Pv and corresponding measurement signal Pv.

The acoustic system has been described as an acoustic system that operates based on an acoustic signal reproduced in real time. However, (i) a signal obtained by causing the original acoustic signal to transmit through a correction filter or by convolving the correction filter with the original acoustic signal and (ii) a signal to which a fixed delay corresponding to the correction filter is added may be prepared in advance in a storage device, and these signals may be synchronized and reproduced. Then, the first signal may be supplied to the vibrator and the latter signal may be supplied to the sound generation device.

In property generation system 300, second changeover switch 372 and third changeover switch 373 have been described as being placed on the output terminal sides of first measurement amplifier 361 and second measurement amplifier 362. However, second changeover switch 372 and third changeover switch 373 may be placed on the input terminal sides.

If a voltage-driven amplifier whose output impedance is sufficiently low is used as a measurement amplifier in this case, short-circuiting the input terminal of the measurement amplifier to the grounding potential produces the same advantageous effect as short-circuiting a changeover switch located on the output terminal side.

Acoustic system 100 according to aspect 1 includes: sound generation device 110, vibrator 120 that generates an excitation force to be applied to vibration member 220 to which vibrator 120 is attached, and connection member 170 that is placed between at least one of (i) sound generation device 110 or structural member 230 that is connected with sound generation device 110 and vibrator 120 or (ii) vibrator 120 and vibration member 220, and connects sound generation device 110 or structural member 230 and vibration member 220 with vibrator 120 interposed therebetween.

According to aspect 1, connection member 170 can set a specific displacement criterion for a connection between vibrator 120 and sound generation device 110. Accordingly, the accuracy of controlling the vibration of vibrator 120 can be improved.

Acoustic system 100 according to aspect 2 includes aspect 1, and in acoustic system 100, connection member 170 at least partially includes, in an aligned direction in which vibration member 220 and structural member 230 are aligned, deformation portion 171 that deforms when a force stronger than the maximum force to be received from vibrator 120 is applied.

According to the above, when an involuntary force is applied in an extension direction in which connection member 170 extends, deformation of deformation portion 171 prevents vibrator 120 from protruding from vibration member 220 or from structural member 230.

Acoustic system 100 according to aspect 3 includes aspect 1 or 2, sound generation device 110 that generates a sound wave based on acoustic signal 201, and correction filter 130 that corrects acoustic signal 201 to reduce transmitted sound that has changed from the sound wave by transmitting through vibration member 220, and outputs the corrected acoustic signal 201 to vibrator 120.

According to aspect 3, it is possible to reduce an amount of sound waves emitted by sound generation device 110 transmitting through vibration member 220.

Acoustic system 100 according to aspect 4 includes aspect 3, and in acoustic system 100, vibrator 120 is attached to sound generation device 110 on a side closer to vibration member 220, and connection member 170 is placed between at least one of (i) structural member 230, and vibrator 120 and sound generation device 110 which are integrally fixed or (ii) vibrator 120 and sound generation device 110 which are integrally fixed, and vibration member 220, and connects structural member 230 and vibration member 220 with vibrator 120 and sound generation device 110 interposed therebetween.

According to aspect 4, sound generation device 110, vibrator 120, and connection member 170 can be placed, as one integrated unit, between connection member 170 and structural member 230. Accordingly, it is possible to increase efficiency of installing acoustic system 100.

Acoustic system 100 according to aspect 5 includes aspect 3 or 4, and further includes delay filter 140 that delays acoustic signal 201, and outputs the delayed acoustic signal delayed to sound generation device 110.

According to aspect 5, it is possible to correct delay caused by, for example, a difference between a path through which acoustic signal 201 to be output to sound generation device 110 passes and a path through which acoustic signal 201 to be output to vibrator 120 passes, to effectively reduce the amount of sound that transmits through vibration member 220.

The acoustic system according to aspect 6 includes any one of aspects 3 to 5, and further includes common filter 150 that corrects both (i) acoustic signal 201 to be output to vibrator 120 and (ii) acoustic signal 201 to be output to sound generation device 110.

According to aspect 6, it is possible to cut a signal component that cannot be reduced due to vibration of vibration member 220 caused by vibrator 120, to reduce the amount of sound that transmits through vibration member 220.

Acoustic system 100 according aspect 7 includes any one of aspects 3 to 6, and in acoustic system 100, correction filter 130 has a filter property derived based on a target sound-pressure function between a target measurement signal and acoustic signal 201. The target measurement signal is obtained by measuring, on a side of vibration member 220 excluding a side of vibration member 220 on which sound generation device 110 is placed, at least one of (i) a sound wave generated by sound generation device 110 based on acoustic signal 201 or (ii) vibration of vibration member 220 caused by the sound wave generated by sound generation device 110.

According to aspect 7, correction filter 130 that conforms to actual conditions can be introduced to acoustic system 100.

Accordingly, the amount of sound that transmits through vibration member 220 can be effectively reduced.

Acoustic system 100 according to aspect 8 includes any one of aspects 3 to 7, and in acoustic system 100, correction filter 130 has a filter property derived based on a corresponding sound-pressure transfer function between a corresponding measurement signal and acoustic signal 201. The corresponding measurement signal is obtained by measuring, at a position at which the target measurement signal has been measured, at least one of (i) a sound wave generated as a result of vibrator 120 causing vibration member 220 to vibrate based on acoustic signal 201 or (ii) the vibration.

According to aspect 8, acoustic system 100 can include correction filter 130 having a filter property in which actual conditions are accurately reflected. Accordingly, transmission of sound waves generated by sound generation device 110 can be effectively reduced by vibrator 120 causing vibration member 220 to vibrate.

An acoustic system control method according to aspect 9 is an acoustic system control method of controlling acoustic system 100 according to any one of aspects 3 to 8. The acoustic system control method includes: placing sound generation device 110 on one side of vibration member 220 to which vibrator 120 is attached; placing a measurement device on the other side of vibration member 220; obtaining a target measurement signal by causing the measurement device to measure a sound wave generated by sound generation device 110 based on acoustic signal 201; and setting a filter property of correction filter 130 based on a target sound-pressure transfer function between acoustic signal 201 and the target measurement signal.

According to aspect 9, it is possible to reduce the amount of sound waves emitted by sound generation device 110 transmitting through vibration member 220.

An acoustic system manufacturing method according to aspect 10 is an acoustic system manufacturing method of manufacturing acoustic system 100 according to any one of aspects 3 to 8. The acoustic system manufacturing method includes: placing sound generation device 110 on one side of vibration member 220 to which vibrator 120 is attached; placing a measurement device on the other side of vibration member 220; obtaining a target measurement signal by causing the measurement device to measure at least one of (i) a sound wave generated by sound generation device 110 based on acoustic signal 201 or (ii) vibration of vibration member 220 caused by the sound wave generated by sound generation device 110; and setting a filter property of correction filter 130 based on a target sound-pressure transfer function between acoustic signal 201 and the target measurement signal.

According to aspect 10, it is possible to manufacture acoustic system 100 that can reduce the amount of sound waves emitted by sound generation device 110 transmitting through vibration member 220.

Acoustic system manufacturing method according to aspect 11 includes aspect 10, and further includes obtaining a corresponding measurement signal by causing the measurement device to measure, at a position at which the target measurement signal has been measured, a sound wave generated as a result of vibrator 120 causing vibration member 220 to vibrate based on acoustic signal 201 or the vibration; and setting the filter property of correction filter 130 based on a corresponding sound-pressure transfer function between acoustic signal 201 and the corresponding measurement signal.

According to aspect 11, it is possible to manufacture acoustic system 100 that includes correction filter 130 having a filter property in which actual conditions are accurately reflected.

The acoustic system manufacturing method according to aspect 12 includes aspect 10 or 11, and in the acoustic system manufacturing method, the target measurement signal is obtained in a state in which vibrator 120 is short-circuited.

According to aspect 12, highly accurate filter property G can be generated.

The acoustic system manufacturing method according to aspect 13 includes any one of aspects 10 to 12, and in the acoustic system manufacturing method, the filter property of correction filter 130 is set based on a process sound-pressure transfer function between a processed signal and acoustic signal 201. The processed signal is obtained by performing statistical processing on target measurement signals measured at different positions.

According to aspect 13, sound transmitting through vibration member 220 can be captured in a plane. Accordingly, it is possible to effectively reduce transmitted sound in a desired area.

While various embodiments have been described herein above, it is to be appreciated that various changes in form and detail may be made without departing from the spirit and scope of the present disclosure as presently or hereafter claimed.

Further Information about Technical Background to this Application

The disclosure of the following patent application including specification, drawings, and claims are incorporated herein by reference in their entirety: Japanese Patent Application No. 2023-218519 filed on Dec. 25, 2023.

### INDUSTRIAL APPLICABILITY

The present disclosure is applicable to mobile objects, buildings, and the like having a space in which an amount of sound waves that is generated in a first space transmitting through vibration member 220 and leaking into a second space is desired to be reduced.

1. An acoustic system comprising:
a sound generation device that generates a sound wave based on an acoustic signal;
a vibrator that generates an excitation force to be applied to a vibration member to which the vibrator is attached; and
a connection member that is placed between at least one of (i) the sound generation device or a structural member and the vibrator or (ii) the vibrator and the vibration member, and connects the sound generation device or the structural member and the vibration member with the vibrator interposed therebetween, the structural member being directly or indirectly connected with the sound generation device.

2. The acoustic system according to claim 1, wherein
the connection member at least partially includes, in an aligned direction in which the vibration member and the structural member are aligned, a deformation portion that deforms when a force stronger than a maximum force to be received from the vibrator is applied.

3. The acoustic system according to claim 1, comprising:
a sound generation device that generates a sound wave based on an acoustic signal; and
a correction filter that corrects the acoustic signal to reduce transmitted sound that has changed from the sound wave by transmitting through the vibration member, and outputs the acoustic signal corrected to the vibrator.

4. The acoustic system according to claim 3, wherein
the vibrator is attached to the sound generation device on a side closer to the vibration member, and
the connection member is placed between at least one of (i) the structural member, and the vibrator and the sound generation device which are integrally fixed or (ii) the vibrator and the sound generation device which are integrally fixed, and the vibration member, and connects the structural member and the vibration member with the vibrator and the sound generation device interposed therebetween.

5. The acoustic system according to claim 3, further comprising:
a delay filter that delays the acoustic signal, and outputs the acoustic signal delayed to the sound generation device.

6. The acoustic system according to claim 3, further comprising:
a common filter that corrects both (i) the acoustic signal to be output to the vibrator and (ii) the acoustic signal to be output to the sound generation device.

7. The acoustic system according to claim 3, wherein
the correction filter has a filter property derived based on a target sound-pressure function between a target measurement signal and the acoustic signal, the target measurement signal being obtained by measuring, on a side of the vibration member excluding a side of the vibration member on which the sound generation device is placed, at least one of (i) a sound wave generated by the sound generation device based on the acoustic signal or (ii) vibration of the vibration member caused by the sound wave generated by the sound generation device.

8. The acoustic system according to claim 7, wherein
the correction filter has a filter property derived based on a corresponding sound-pressure transfer function between a corresponding measurement signal and the acoustic signal, the corresponding measurement signal being obtained by measuring, at a position at which the target measurement signal has been measured, at least one of (i) a sound wave generated as a result of the vibrator causing the vibration member to vibrate based on the acoustic signal or (ii) the vibration.

9. An acoustic system control method of controlling the acoustic system according to claim 3, the acoustic system control method comprising:
placing the sound generation device on one side of the vibration member to which the vibrator is attached;
placing a measurement device on an other side of the vibration member;
obtaining a target measurement signal by causing the measurement device to measure a sound wave generated by the sound generation device based on the acoustic signal; and
setting a filter property of the correction filter based on a target sound-pressure transfer function between the acoustic signal and the target measurement signal.

10. The acoustic system control method according to claim 9, further comprising:
obtaining a corresponding measurement signal by causing the measurement device to measure, at a position at which the target measurement signal has been measured, a sound wave generated as a result of the vibrator causing the vibration member to vibrate based on the acoustic signal or the vibration; and
setting the filter property of the correction filter based on a corresponding sound-pressure transfer function between the acoustic signal and the corresponding measurement signal.

11. The acoustic system control method according to claim 9, wherein
the target measurement signal is obtained in a state in which the vibrator is short-circuited.

12. The acoustic system control method according to claim 9, wherein
the filter property of the correction filter is set based on a process sound-pressure transfer function between a processed signal and the acoustic signal, the processed signal being obtained by performing statistical processing on target measurement signals measured at different positions, the target measurement signals each being the target measurement signal.

13. An acoustic system manufacturing method of manufacturing the acoustic system according to claim 3, the acoustic system manufacturing method comprising:
placing the sound generation device on one side of the vibration member to which the vibrator is attached;
placing a measurement device on an other side of the vibration member;
obtaining a target measurement signal by causing the measurement device to measure at least one of (i) a sound wave generated by the sound generation device based on the acoustic signal or (ii) vibration of the vibration member caused by the sound wave generated by the sound generation device; and
setting a filter property of the correction filter based on a target sound-pressure transfer function between the acoustic signal and the target measurement signal.

14. The acoustic system manufacturing method according to claim 13, further comprising:
obtaining a corresponding measurement signal by causing the measurement device to measure, at a position at which the target measurement signal has been measured, a sound wave generated as a result of the vibrator causing the vibration member to vibrate based on the acoustic signal or the vibration; and
setting the filter property of the correction filter based on a corresponding sound-pressure transfer function between the acoustic signal and the corresponding measurement signal.

15. The acoustic system manufacturing method according to claim 13, wherein
the target measurement signal is obtained in a state in which the vibrator is short-circuited.

16. The acoustic system manufacturing method according to claim 13, wherein
the filter property of the correction filter is set based on a process sound-pressure transfer function between a processed signal and the acoustic signal, the processed signal being obtained by performing statistical processing on target measurement signals measured at different positions, the target measurement signals each being the target measurement signal.
